(19) United States
(12) Patent Application Publication
(10) Pub. No.: US 2007/0028189 A1
(43) Pub. Date: Feb. 1, 2007

(54) Hierarchy highlighting

(75) Inventor: Daniel C. Robbins, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/190,698

(22) Filed: Jul. 27, 2005

(51) Int. Cl. G06F 17/00

(52) U.S. Cl. 715/853

(57) ABSTRACT

Indicating degrees of relatedness between a visual element in a graphical user interface (GUI) representing a software object and other visual elements in the GUI representing other software objects is disclosed. The visual elements may, or may not, be in the same view in the GUI. Embodiments may indicate degrees of relatedness by modifying the appearance of visual elements in response to an action on the visual element representing a software object; on the visual elements representing the other software objects; on the software object; or on one or more of the other software objects. Embodiments may indicate degrees of relatedness by applying hierarchical levels of highlighting to visual elements; by applying hierarchical changes to visual elements; or by other hierarchical visual cues applied to visual elements.

### BACKGROUND

Users often interact with computing devices via graphical user interfaces. A graphical user interface (GUI) is a computer software program that enables users to view and manipulate visual elements that represent software objects. Certain software objects may also be associated with or represent hardware objects such as disc drives, printers, servers, switches, other peripheral devices, other computing devices, and the like. The visual elements are viewed on a display and manipulated by actions such as moving and clicking a computer mouse, typing on a keyboard, pressing buttons on a keypad, and etc.

In many GUIs, “highlighting” is used to call attention to a visual element, e.g., indicate that a visual element is selected. When a visual element is highlighted, the appearance of the visual element is altered in a way that calls attention to the visual element while keeping the visual element recognizable. Common examples of highlighting include reversing the intensity of the colors of a visual element to create a “negative” image; overlaying a visual element with a transparent color rectangle or other shape; changing the hue, saturation, or value of the colors of a visual element; etc. More than one visual element may be highlighted at a time.

In certain GUIs, highlighting a visual element in one view may cause a visual element, perhaps in another view, to become highlighted. This technique is often used to show a relationship between the software objects the two visual elements represent. For example, when a word in a list of words is highlighted, the synonyms of the highlighted word may also be highlighted. The highlighted synonyms may or may not be in the same list or view as the highlighted word. It can be said that the highlighted word is related to the synonyms, and the synonyms are related to the highlighted word. Those skilled in the art often refer to techniques of visualizing such relationships as “brushing.” Brushing is an interactive method of indicating the “relatedness” between software objects, e.g., data items, represented by visual elements. While indicating “relatedness” is useful, it would be even more useful to indicate degrees of relatedness, i.e., the degree to which a software object is related to other software objects. In the aforementioned example, it would be useful to indicate how much a synonym is “like” the highlighted word.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Indicating degrees of relatedness between a visual element in a graphical user interface (GUI) representing a software object and other visual elements in the GUI representing other software objects is described. The visual elements may, or may not, be in the same view. The indication of the degree of relatedness may be caused by an action on the visual element representing a software object; on the visual elements representing the other software objects; on the software object; or on one or more of the other software objects. The degrees of relatedness may be indicated by applying hierarchical levels of highlighting to visual elements; by applying hierarchical sizes to visual elements; or by other hierarchical visual cues applied to visual elements.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial illustration of an exemplary window containing two exemplary panes each containing exemplary visual elements representing exemplary software objects;

FIG. 2 is a pictorial illustration of the exemplary window of FIG. 1 containing the two exemplary panes of FIG. 1 with one exemplary visual element in the left pane selected, i.e., highlighted, and visual elements in the right pane modified to show the visual elements' degrees of relatedness to the selected visual element in the left pane;

FIG. 3 is a pictorial illustration of the exemplary window of FIG. 1 containing the two exemplary panes of FIG. 1 with one exemplary visual element in the right pane selected, i.e., highlighted, and one visual element in the left pane modified to show the visual element's degree of relatedness to the selected visual element in the right pane;

FIG. 4 is a pictorial illustration of an exemplary directory tree with highlighting to show the degree of relatedness of items in the left pane;

FIG. 5 is a pictorial illustration of an exemplary directory tree with highlighting to show the degree of relatedness of items in the right pane; and

FIG. 6 is a flow diagram showing how hierarchy highlighting is applied to an exemplary directory tree.

### DETAILED DESCRIPTION

Embodiments of the invention provide a method and apparatus, including computer readable medium, that enables the representation of degrees of relatedness among software objects represented in graphical user interfaces (GUIs). A graphical user interface (GUI) is a computer software program that operates on a computing device and enables users to view and manipulate visual elements that represent software objects. The GUI may or may not operate on the same computing device that stores the software objects. The visual elements are viewed on a display and manipulated by actions such as moving and clicking a computer mouse, typing on a keyboard, pressing buttons on a keypad, etc. Embodiments may encompass actions other than those provide by keyboards, mice, etc. Thus, the aforementioned actions should be construed as exemplary and not limiting.

In a GUI, a visual element may be placed inside of a “window” or a “pane” of a window. A window is a bounded region of a display that is dedicated to presenting a particular software object or set of software objects and/or providing a particular set of functions, i.e., actions. A window or pane provides a view of visual elements. For example, an email program provides a window in which to view email messages represented by visual elements. The email program usually provides functions, i.e., actions, such as, but not limited to, creating, editing, and organizing email messages. The visual elements may, or may not, be placed in panes. A pane is a bounded subregion within a window that is usually dedicated to working with a subset of the software objects and/or functions provided by the containing window. An action applied to a visual element may cause the appearance of the visual element to change. One such appearance change is “highlighting.”

Often highlighting is used in a GUI to call attention to one or more visual elements in the GUI. Highlighting may be used to indicate that one or more visual elements in the GUI are selected. Highlighting may also be used to indicate that an action is being performed, about to be performed, or has been performed, on software objects represented by the highlighted visual elements. Highlighting may also be used to indicate other activities involving visual elements and the software objects the visual elements represent. Thus, highlighting to indicate selecting or acting upon software objects should be construed as exemplary and not limiting. When a visual element is highlighted, the appearance of the visual element is altered in a way that calls attention to the visual element while keeping the visual element recognizable. Examples of highlighting include, but are not limited to: reversing the intensity of the colors of a visual element to create a “negative” image; overlaying a visual element with a transparently colored shape, e.g., a rectangle, circle, or oval; or changing the hue, saturation, and/or value of the colors of a visual element. Those skilled in the art will appreciate that hue is the color attribute determined by a color's dominant wavelength. For example, a color with a dominant wavelength of 700 nanometers has a red hue. Saturation is the color attribute describing the color's purity. For example, a color comprising a plurality of electromagnetic waves whose lengths are, or are close to, 700 nanometers is a highly saturated red color and appears vividly red. Contrarily, a color comprising a plurality of electromagnetic waves whose lengths range from 400 to 700 nanometers is less saturated and appears to be muted or gray. Value is the color attribute describing the amount of light, i.e., darkness or lightness, in a color independent of the color's hue and saturation. For example, a red tomato illuminated by a dim white light appears to be darker, i.e., have a lower value, than a red tomato illuminated by a bright white light.

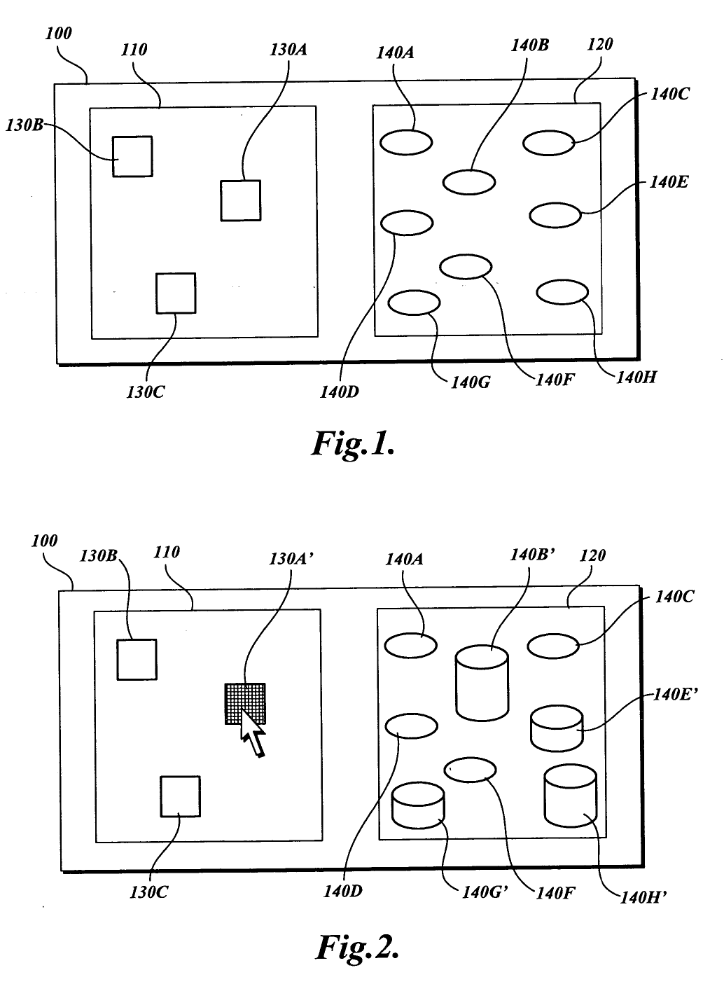

An action applied to a visual element that causes a change to the visual element's appearance, e.g., highlighting the visual element, may also cause a change in the appearance of visual elements in the same pane or the visual elements in one or more different panes. For example, FIGS. 1 and 2 illustrate how an action on a visual element in one pane can affect the appearance of the visual element and the appearance of visual elements in a different pane. FIG. 1 shows a window 100 in a GUI. Within the window 100 are a left pane 110 and a right pane 120. The left pane 110 contains a plurality of square shaped visual elements, 130A, 130B, 130C. The right pane 120 contains a plurality of oval shaped visual elements, 140A, 140B, 140C, 140D, 140E, 140F, 140G, 140H. FIG. 2 shows the window 100, from FIG. 1, after one of the squares 1 30A in the left pane 110 has been selected. The selection of the square 130A is indicated by the highlighting of the square 130A′. The selection of the highlighted square 130A′ also causes an appearance change to several of the ovals 140B, 140E, 140G, 140H in the right pane 120. The ovals are rendered as three dimensional cylinders, 140B′, 140E′, 140G′, 140H′, each with a different height.

If the squares in left pane 110 and the ovals in right pane 120 are used to represent software objects, e.g., a data items, and if a data item represented by the highlighted square 130A′ in left pane 110 is related to certain data items represented by cylinders 140B′, 140E′, 140G′, 140H′ in the right pane, a relationship between the highlighted square 130A′ and the cylinders 140B′, 140E′, 140G′, 140H′ can be shown by appearance changes to the original square 130A and the ovals 140B, 140E, 140G, 140H that become cylinders. Further, if the data item represented by the highlighted square 130A′ is related in varying degrees to the data items represented by the ovals 140B, 140E, 140G, 140H that change into cylinders, the degrees of relatedness can be indicated by the varying heights of the cylinders, for example. In this example, the height of one of the cylinders 140B′ is greater than the height of the other cylinders 140E′, 140G′, 140H′. The height difference can be used to indicate that the data item associated with the cylinder 140B′ has a higher degree of relatedness to the data item associated with the highlighted square 130A′ than data items associated with the other cylinders 140E′, 140G′, 140H′. Similarly, the height of the cylinder 140H′ of the remaining cylinders is greater than the height of the other cylinders 140E′, 140G′ denoting that the data item associated with the intermediate height cylinder 140H′ has a higher degree of relatedness to the data item associated with the highlighted square 130A′ than the data items associated with the lowest cylinders 140E′, 140G′.

Note that highlighting that indicates a range of values, i.e., hierarchical highlighting, is not limited to the display of trees and other nested hierarchies. Hierarchical highlighting can also be used to denote relationships between items in a network. In a general data network, relationships are denoted by links between data items. Any item can be connected (linked) to any number of other items. Some items are essentially “siblings” in that the items are directly connected to each other. Other items may have several levels of indirection between them. For example, in a network comprising items A, B, C, and D, item A may be connected to item B. Item C may be connected to Item B but not item A. Item D may be connected to item C and item A. Hierarchical highlighting can be used to show degrees of connectedness, i.e., relatedness, within a network. When selected, items that are related by degrees of relatedness are highlighted with an indicator, e.g., a color's value, that is in proportion to the degree of relatedness to the selected item. There are a plurality of functions available to determine the indicator values in a hierarchical highlighting scheme. Such functions include, but are not limited to, linear, logarithmic, and perceptually based functions.

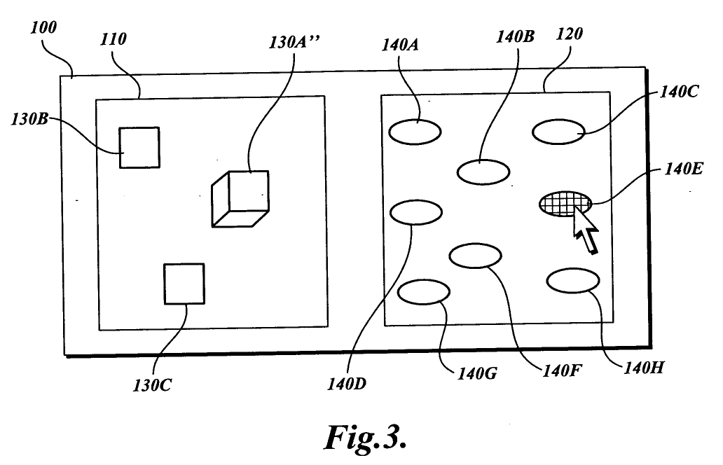

Showing the relationships between a data item in one pane, i.e., the left pane 110, and data items in another pane, i.e., right pane 120, is often referred to by those skilled in the art as “brushing.” Brushing is an interactive method of indicating the relatedness between data items represented by visual elements. Relatedness, and hence brushing effects, may be bidirectional. For example, the data item associated with the highlighted square 130A′ is related to data items associated with the cylinders 140B′, 140E′, 140G′, 140H′. Thus, an action on the highlighted square 130A′ causes the original ovals to change to cylinders. Since the data items associated with the cylinders 140B′, 140E′, 140G′, 140H′ are related to the data item associated with the highlighted square 130A′, an action on any of the ovals that change to cylinders will cause an appearance change to the highlighted square 130A′. FIG. 3 illustrates such appearance changes. FIG. 3 shows the window 100, from FIG. 1, after one of the ovals 140E in the right pane 120 whose data item is related to the previously highlighted (FIG. 2) square 130A′ has been selected. Selecting this oval 140E causes the appearance of the square 130A in the left pane 110 to change to the right rectangular prism 130A″. The height of the right rectangular prism 130A″ indicates the degree of relatedness of the data item associated with the right rectangular prism 130A″ to the data item associated with the selected oval 140E.

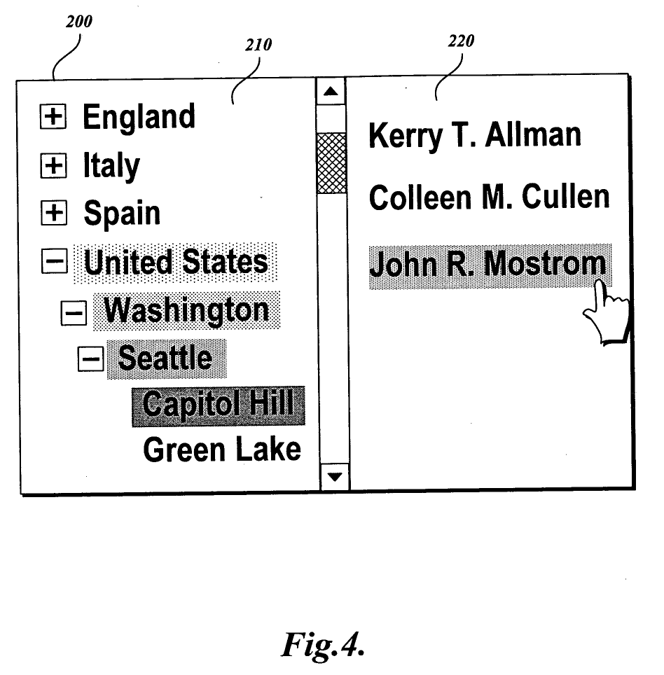

The degrees of relatedness shown in brushing can be implemented using hierarchical highlighting, rather than geometric techniques. Hierarchical highlighting allows degrees of relatedness to be indicated by using levels of color, saturation, and/or value. FIG. 4 illustrates how hierarchical highlighting is used to show the relatedness and degrees of relatedness between a person and the location of the person's residence in a hierarchical tree. More specifically, FIG. 4 shows a window 200 in a GUI containing two panes separated by a scroll bar. The left pane 210 contains a hierarchical list of locations. The right pane 220 contains an exemplary list of three names. Those skilled in the art will appreciate that the location list in the left pane 210 represents a “tree” data structure and that a list such as the location list may be referred to as a location tree.

The location tree hierarchically lists countries, states, cities, and neighborhoods, i.e., countries contain states that contain cities that contain neighborhoods. If an element in the location tree contains other elements, a box is placed to the left of the element. A plus sign (+) in the box indicates that the element is “closed” and the elements the element contains are not shown. A minus sign (−) in the box indicates that the element is “open” and the elements the element contains are shown. A containment relationship is indicated by indenting the contained elements and listing the contained elements below the containing element. Exemplary countries in the location tree are England, Italy, Spain, and the United States. Contained within the United States is the state of Washington. Contained in the state of Washington is the city of Seattle. Contained in the city of Seattle are the neighborhoods Capitol Hill and Green Lake. The neighborhoods do not contain elements. Thus, no box is placed next to the neighborhoods.

The right pane 220 in FIG. 4 contains a list of three names: Kerry T. Allman, Colleen M. Cullen, and John R. Mostrom. The name John R. Mostrom is highlighted in medium gray and a cursor is placed over the name, indicating that John R. Mostrom is selected. In the location tree in the left pane 210, Capitol Hill is highlighted in dark gray; Seattle in medium gray; Washington in light gray; and the United States in very light gray. None of the other locations in the location tree are highlighted. The highlighting of a location in the location tree in the left pane 210 indicates how closely the location specifies the locus of the residence of the person whose name is highlighted in the right pane 220. The darker the highlight, the more closely the location specifies the locus of the residence, i.e., the darker the highlight the higher the degree of relatedness. Since John R. Mostrom lives in Capitol Hill, Capitol Hill has the darkest highlight. Because Capitol Hill is in Seattle, and hence approximates the locus of John R. Mostrom's residence, Seattle is also highlighted, but not as darkly as Capitol hill. Similarly, because Seattle is in Washington, Washington is lightly highlighted. Because Washington is in the United States, the United States is highlighted, but has the lightest highlight of the four highlighted locations.

If another name, e.g., Colleen M. Cullen, were selected, and that person's residence were in another neighborhood of Seattle, for instance Green Lake, then Green Lake would have a dark highlight and Capitol Hill would have no highlight. However, the highlighting for Seattle, Washington, and the United States would remain the same because Green Lake is contained in the highlighted locations. Note that a name may be selected from the name list by actions other than those available in the GUI. For example, if the computing device on which the GUI is operating is connected to another computer, e.g., a web server, via a network, a name may be selected from the name list by an action on the web server.

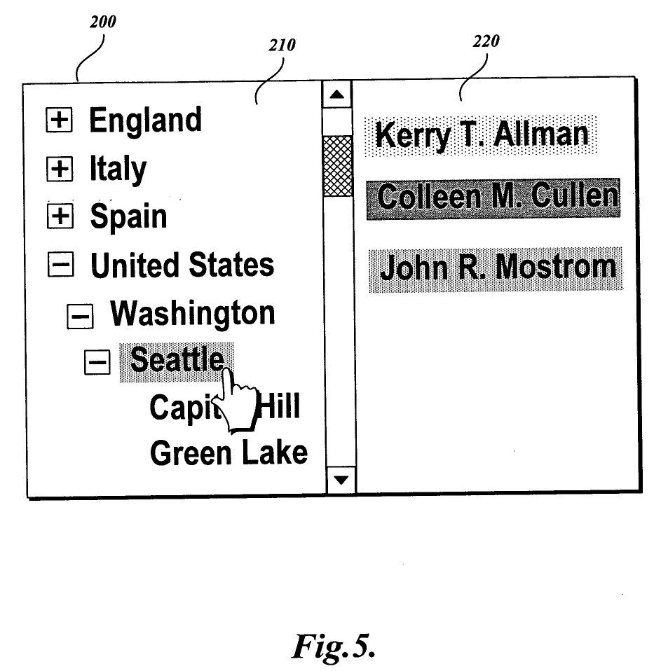

FIG. 5 shows the same window 200, the same panes 210 and 220, and the same contents of panes 210 and 220 as those shown in FIG. 4. However, in FIG. 5, instead of the name John R. Mostrom in the right pane 220 being selected, the city of Seattle in the left pane 210 is selected, i.e., a cursor is placed over Seattle and Seattle is highlighted. In the right pane 220 of window 200 in FIG. 5, the name of each person is highlighted according to how close each person's residence is to Seattle, i.e., Seattle's center. Since the residences of the three persons listed in the right pane 220 are in Seattle, the residences are close to Seattle's center. How close each residence is to Seattle's center is indicated by the darkness of the highlights on each name. Kerry T. Allman has the lightest highlight because his residence is the furthest from Seattle's center. Colleen M. Cullen has the darkest highlight because her residence is the closest to Seattle's center. John R. Mostrom has a medium highlight because the distance from his residence to Seattle's center is not as far as Kerry T. Allman's and not as close as Colleen M. Cullen's.

The “graying” depiction shown in FIGS. 4 and 5 should, of course, be construed as exemplary and not limiting. In certain embodiments of the invention employing contemporary color monitors or displays, the “gray” depiction may be replaced by different shades of some color or by different colors, for example. Other ways of indicating relationship changes, such as the change from two dimensional to three dimensional images as described above with respect to FIGS. 2 and 3 can be used.

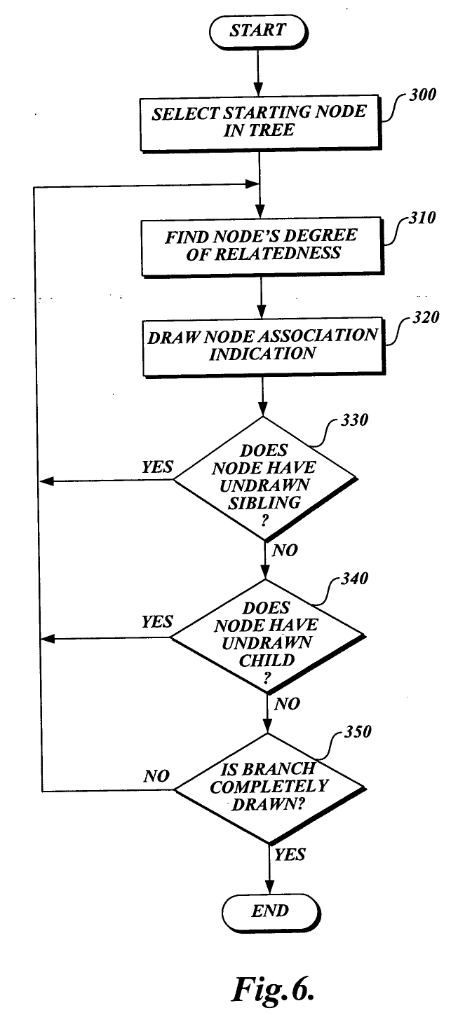

The hierarchical highlighting described above and illustrated in FIGS. 4 and 5 may be implemented by an exemplary process illustrated by the functional flow diagram shown in FIG. 6. Relationship structures, such as the tree structure represented by the location tree shown in FIG. 4 and 5, store elements in nodes. Those skilled in the art will appreciate that a plurality of related nodes may be connected to a common node forming a “branch.” The common node of a branch may be connected to the common nodes of other related branches forming a larger and more complex branch. Branches are connected to form a tree. The nodes in the branches of a tree can be “visited,” i.e., accessed, and the data contained in the element of a node can be extracted and used. For example, elements for Capitol Hill and Green Lake may be placed in nodes. The two nodes may form a branch connected to a node for a “city” element, such as Seattle, in a branch of cities, i.e., a city branch. A city branch may be connected to a node for a “state” branch element, such as Washington, of a branch of states, i.e., a state branch and so on until the location tree is populated.

FIG. 6 is a functional flow diagram showing how hierarchical highlighting is applied to an exemplary tree, such as a location tree, or a branch within the tree. At block 300, the starting node is selected. If every node in the entire tree is to be visited, the “root” node is selected. Those skilled in the art will appreciate that the root node is the node to which all branches in a tree are connected, either directly or indirectly. If only the nodes in a part of the tree need to be visited, the common node for the branch is selected, i.e., becomes the selected node. At block 310, the selected node is visited. The data about the degree of relatedness, i.e., degree, stored in the element of the selected node is read. At block 320, the degree is used to determine how to draw the “relatedness indicator,” e.g., the highlight of the visual element that represents the element in the selected node. For example, in FIG. 4, Capitol Hill has a high degree of relatedness so the highlight for Capitol Hill, i.e., the relatedness indicator for Capitol Hill, is dark gray. At block 330, the selected node is examined to see if the node has an undrawn sibling, i.e., another node in the same branch as the selected node. If the selected node has an undrawn sibling, then the undrawn sibling node becomes the selected node and control flows back through block 310. If the node does not have an undrawn sibling, then the control flows to block 340. At block 340, it is determined if the selected node has an undrawn child, i.e., a node in a branch attached directly to the selected node. If the selected node has an undrawn child node, then the undrawn child node becomes the selected node and control flows back through block 310. If the selected node does not have an undrawn child, then the control flows to block 350. At block 350, a check is made to see if all nodes in the branch have been drawn. If the branch has been completely drawn, then the process ends. If a nested array has not been completely drawn, the control flows back through block 310.

In the process illustrated in FIG. 6 and described above, the value, i.e., darkness or lightness, of the color of a highlight is used to indicate relatedness. As noted above, other color attributes and ranges of color attributes may be used to indicate relatedness without departing from the spirit and scope of the appended claims. For example, as noted above, the hue of the color of a highlight may be used to indicate relatedness. Other visual cues may be used to indicate relatedness without departing from the spirit and scope of the appended claims. For example, a three dimensional change, the size or font of a visual element may be used to indicate relatedness.

Although the subject matter has been described in language specific to structural features and/or methodological acts, it is to be understood that the subject matter defined in the appendant claims is not necessarily limited to the specific features or acts described above. Rather, the specific features and acts described above are disclosed as example forms of implementing the claims.

1. A method for indicating degrees of relatedness between a visual element in a view in a graphical user interface (GUI) representing a software object, and other visual elements in the GUI, each representing other software objects, the method comprising:
analyzing the relationships between the software object and the other software objects;
selecting relatedness indicators according to the relationship analysis; and
rendering relatedness indicators for each visual element.

2. The method of claim 1 wherein the visual element is in the same view as the other visual elements.

3. The method of claim 1 wherein the visual element is in a different view from the other visual elements.

4. The method of claim 1 wherein the indication of degree of relatedness is in response to an action on the visual element representing the software object.

5. The method of claim 1 wherein the indication of degree of relatedness is in response to an action on one of the other visual elements representing the other software objects.

6. The method of claim 1 wherein the indication of degree of relatedness is in response to an action on the software object represented by the visual element.

7. The method of claim 1 wherein the indication of degree of relatedness is in response to an action on one of the other software objects represented by the other visual elements.

8. The method of claim 1 wherein the degrees of relatedness are indicated by applying hierarchical levels of highlighting to the other visual elements.

9. The method of claim 1 wherein the degrees of relatedness are indicated by a hierarchical change to the other visual elements.

10. The method of claim 1 wherein the degrees of relatedness are indicated by applying a hierarchical visual cue to the other visual elements.

11. A computer readable medium including computer executable code that, when executed by a computing device that includes a display and a processing unit:
analyzes the relationships between a software object represented by a visual element in a view in a GUI and other software objects represented by other visual elements in the GUI;
selects relatedness indicators according to the relationship analysis; and
renders relatedness indicators for each visual element.

12. The computer readable medium of claim 11 wherein the visual element is in the same view as the other visual elements.

13. The computer readable medium of claim 11 wherein the visual element is a different view from the other visual elements.

14. The computer readable medium of claim 11 wherein the indication of degree of relatedness is in response to an action on the visual element representing the software object.

15. The computer readable medium of claim 11 wherein the indication of degree of relatedness is in response to an action on one of the other visual elements representing the other software objects.

16. The computer readable medium of claim 11 wherein the indication of degree of relatedness is in response to an action on the software object represented by the visual element.

17. The computer readable medium of claim 11 wherein the indication of degree of relatedness is in response to an action on one of the other software objects represented by the other visual elements.

18. The computer readable medium of claim 11 wherein the degrees of relatedness are indicated by applying hierarchical levels of highlighting to the other visual elements.

19. The computer readable medium of claim 11 wherein the degrees of relatedness are indicated by a hierarchical change to the other visual elements.

20. The computer readable medium of claim 11 wherein the degrees of relatedness are indicated by applying a hierarchical visual cue to the other visual elements.
